(19) United States
(12) Patent Application Publication
(10) Pub. No.: US 2008/0206559 A1
(43) Pub. Date: Aug. 28, 2008

(54) LUBRICANT ENHANCED NANOCOMPOSITES

(76) Inventors: YUNJUN LI, Austin, TX (US); Zvi Yaniv, Austin, TX (US); Dongsheng Mao, Austin, TX (US)

Correspondence Address: FISH & RICHARDSON P.C., P.O BOX 1022, Minneapolis, MN, 55440-1022, US

(21) Appl. No.: 12/036,438

(22) Filed: Feb. 25, 2008

Related U.S. Application Data
(60) Provisional application No. 60/891,682, filed on Feb. 26, 2007.

(51) Int. Cl. C08K 3/34; C08K 3/04; A63B 49/00

(52) U.S. Cl. 428/368; 524/612; 524/445; 524/495; 473/543

(57) ABSTRACT

Strings configured for use in sports racquets and musical instruments are fabricated as a plastic core wrapped with one or more filaments of plastic. The strings are coated with a material composite that includes rigid nanoparticles, and lubricated nylon. The rigid nanoparticles may include clay or carbon nanotubes. The strings are coated with the material composite using various processes that result in a coating thickness of between 0.1 and 200 μm. The material composite may further include impact modifiers. The strings experience extended life due to reduced frictional wear and improved mechanical properties.

### CROSS REFERENCE TO RELATED APPLICATION

This application is related to and claims the benefit of priority from U.S. Provisional Application Ser. No. 60/891,682 filed Feb. 26, 2007, the disclosure of which is incorporated by reference.

### TECHNICAL FIELD

The present invention pertains to coatings applied to strings to improve their wear and improve their mechanical properties.

### BACKGROUND AND SUMMARY

The strings used in fabricating sports equipment such as tennis and badminton racquets are coated to improve their durability and other mechanical properties. Musical instruments such as violins may also use coatings on their strings to increase string life. The strings in sports racquets experience movements under high impacts that increase wear and abrasion during use. Lowering the friction of the racquet strings allows the strings to move easier thus improving wear resistance and improving string lifetime.

The strings comprise a material composite comprising rigid nanoparticles, a lubricant, and nylon. In one embodiment the rigid nanoparticles comprise carbon nanotubes or clay particles. The lubricant may comprise graphite, Molybdenum disulfide, Silicone, Teflon®, and Titanium dioxide. The composite may further comprise impact modifiers selected from a set of impact modifiers including styrene-ethylene/butylene-styrene (SEBS), maleic anhydride grafted ethylene and propylene copolymer, a plasticizer, a compatiblizer, and combinations therein. In embodiments, the composite is formed with processes that include extrusion, melt compounding, and in-situ polymerization.

In one embodiment a content of the rigid nanoparticles ranges between 0.1-30% by weight, a content of the lubricant ranges between 0.01-20% by weight, and a content of the nylon ranges between 70-99.9% by weight. The carbon nanotubes may include single-wall carbon nanotubes, double wall carbon nanotubes, multi-wall carbon nanotubes, purified or non-purified carbon nanotubes, metallic or semiconducting carbon nanotubes, or combinations thereof.

In another embodiment, a string configured for use in sporting goods or musical instruments comprises a cylindrical center core of plastic material, one or more outer filaments of plastic material wrapping the core, and a material composite coating applied to the string; the material composite includes rigid nanoparticles, a lubricant, and nylon.

In one embodiment, the coating thickness ranges between 0.1-200 μm. The string may be coated with the material composite using a melt-compounding (extrusion) process or a solution coating process. The rigid nanoparticles comprise carbon nanotubes or clay particles and the lubricant may comprise graphite, molybdenum disulfide, Teflon®, and titanium dioxide. The material composite may further comprise impact modifiers selected from a set of impact modifiers including styrene-ethylene/butylene-styrene (SEBS), maleic anhydride grafted ethylene and propylene copolymer, a plasticizer, a compatiblizer, and combinations therein.

The content of the rigid nanoparticles may range between 0.1-30% by weight, a content of the lubricant ranges between 0.01-20% by weight, and a content of the nylon ranges between 70-99.9% by weight. The carbon nanotubes may include single-wall carbon nanotubes, double wall carbon nanotubes, multi-wall carbon nanotubes, purified or non-purified carbon nanotubes, metallic or semiconducting carbon nanotubes, or combinations thereof.

In another embodiment, a racquet having a net of strings having a cylindrical center core of plastic material, one or more outer filaments of plastic material wrapping the core, and a material composite coating applied to the string, the material composite including rigid nanoparticles, a lubricant, and nylon. The thickness of the coating may range between 0.1-200 μm. The rigid nanoparticles may comprise carbon nanotubes or clay particles and the lubricant may comprise graphite, molybdenum disulfide, Teflon®, and titanium dioxide.

The material composite may further comprise impact modifiers selected from a set of impact modifiers including styrene-ethylene/butylene-styrene (SEBS), maleic anhydride grafted ethylene and propylene copolymer, a plasticizer, a compatiblizer, and combinations therein. The processes forming the material composite may include extrusion, melt compounding, and in-situ polymerization. The content of the rigid nanoparticles may range between 0.1-30% by weight, a content of the lubricant ranges between 0.01-20% by weight and a content of the nylon ranges between 70-99.9% by weight. The carbon nanotubes may include single-wall carbon nanotubes, double wall carbon nanotubes, multi-wall carbon nanotubes, purified or non-purified carbon nanotubes, metallic or semiconducting carbon nanotubes, or combinations thereof.

### BRIEF DESCRIPTION OF DRAWINGS

FIG. 1A is a cross-section of a string with a solid core filament and one or more outer wrapped multi-filaments;

FIG. 1B is a cross-section of a string with a solid core filament and one or more outer wrapped multi-filaments and a coating applied on the string;

FIG. 2 is a table of mechanical properties of lubricant enhanced nylon 6 compared to neat nylon 6;

FIG. 3 is a table of mechanical properties of the lubricant enhanced N6 nanocomposites; and

FIG. 4 illustrates an exemplary racquet using suitable for employing the strings according to embodiments herein.

### DETAILED DESCRIPTION

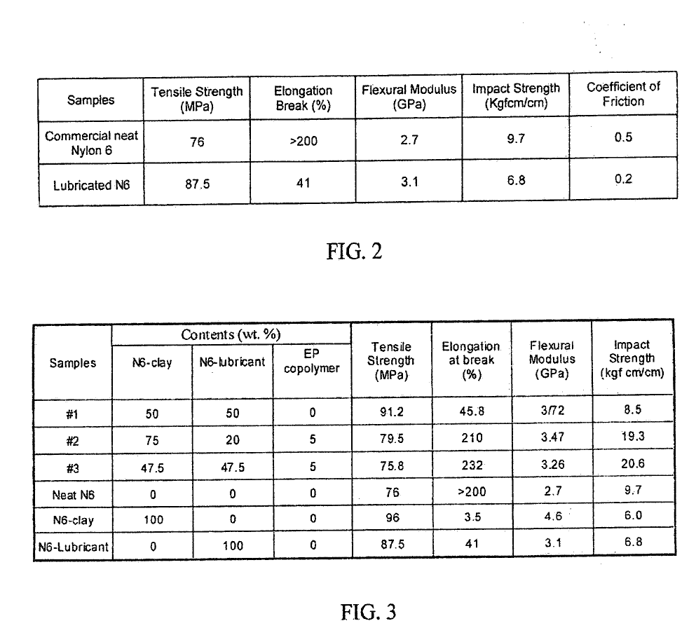

Lubricant enhanced polymer resins have previously been used as a coating of strings in order to reduce friction coefficients. For example, Teflon enhanced resin has been coated onto the strings used for tennis and badminton racquets as described in U.S. Pat. No. 4,377,620. U.S. Pat. No. 6,835,454 describes coating strings with a Fluoropolymer having recurring units containing polar functional groups. Nylon 6 is an excellent engineering polymer material that has been used extensively in various applications. In its pure form without any additives, this material is referred to as “neat” nylon 6 (neat N6). Lubricated nylon has a significantly lower coefficient of friction and better wear characteristics than unmodified polyamide 6, but has slightly reduced tensile strength, elongation at break, and notched izod impact strength than unmodified neat polyamide 6. These nylon resins may be modified with internal lubricants including silicone, molybdenum disulfide, Teflon®, carbon graphite, and titanium dioxide, etc. Without using lubricants, some lubricated nylon may be made by modifying crystalline structures of neat nylon. Lubricated nylon (N6-lubricant) may be used as a low coefficient of friction coating that significantly improves wear resistance. However, compared with neat N6, N6-lubricant may scarify certain mechanical properties of its base material. FIG. 2 shows mechanical properties of N6-lubricant compared to neat N6. This data was obtained from Dupont under the product name: Zytel 7335 NC010.

From FIG. 2, it is evident that the tensile strength and flexural modulus of the lubricant enhanced nylon 6 are higher than those of neat nylon 6. However, N6-lubricant has lower impact strength, elongations, and coefficient of friction. The wear resistance and mechanical properties of N6-lubricant materials may be further enhanced by the addition of rigid nanomaterials such as carbon nanotubes and clays. However, no prior art has applied lubricant enhanced nylon 6 materials as a coating on strings used for sports equipment or for musical instruments.

A combination of rigid nanoparticles such as clay and N6 (N6-clay) may be used to significantly improve the mechanical properties of polymer nanocomposites. Such a polymer nanocomposite, if mixed with an impact modifier, may have further improved properties. The polymer nanocomposite applied as a coating may significantly improve the wear resistance of strings used in sports applications. An exemplary process according to one embodiment is described below:

In-situ polymerized N6-clay was obtained from Nanocor Inc., Chicago, Ill. The clay content was 4% by weight. N6-lubricant was obtained from Dupont Co. under the product name: Zytel 7335 NC010. An impact modifier EP copolymer was obtained from Exxelor Chemical Inc. under the product name Exxelor VA 1840.

N6-lubricant nanocomposites were synthesized by a melt-compounding (extrusion) process. N6-clay, N6-lubricant, and EP copolymer resins were dried separately in a vacuum oven at 70° C. for 12 hours. Before processing with an extruder, the mixture of N6-clay, N6-lubricant, and EP copolymer pellets were well-mixed in a bag or a jar with a tumbler. A Haake Rheomex CTW 100 twin screw extruder was used to melt-compound lubricant enhanced nanocomposites using different ratios of the components. The extruder has three heating zones and a heating die to melt all the polymer components in the barrel to produce a new nanocomposite material. The nanocomposite is extruded from the die to form in a continuous fiber. The following experimental parameters were used in one exemplary process:

Screw zone 1 temperature—240° C.;

Screw zone 1 temperature—230° C.;

Screw zone 1 temperature—230° C.;

Die temperature—240° C.;

Screw speed—50˜100 rpm

The nanocomposite fiber was quenched in water and palletized using a Haake PP1 Pelletizer after the extrusion process. The nanocomposite pellets were dried at 70° C. in a vacuum oven for at least 12 hours prior to the injection molding process to make specimens of “dog-bones” for tensile tests and Izod bars for modulus and impact tests.

The molded samples with specific dimensions conform to ASTM-standards; ASTM D628 for tensile strength testing, ASTM D256 for impact strength testing, and ASTM D790 for flexural modulus testing. The following experimental parameters were used to make specimens for tests by the injection molder:

Injection pressure—70 bar;

Holding pressure—35 bar;

Holding time—20 seconds;

Heating zone 1 temperature—245° C.;

Heating zone 2 temperature—250° C.;

Heating zone 3 temperature—255° C.;

Nozzle temperature—260° C.;

Mold temperature—60-80° C.

FIG. 3 shows mechanical properties of various lubricant enhanced N6 nanocomposites labeled as #1-#3.

Data of neat N6, N6-clay, and N6-lubricant were also put in it for comparison. Composite #1 was the nanocomposite mix of 50 wt. % N6-clay and 50 wt. % N6-lubricant. Composite #1 has better elongation, flexural modulus, and impact strength than those of individual N6-clay and N6-lubricant. Its tensile strength is very close to that of N6-clay. Changing the weight ratio of the three components—N6-clay, N6-lubricant, and EP in composites #2-#3, results in the elongation of the two samples that is as good as neat N6. Composites #2-#3 have flexural modulus and impact strength much higher than that of neat N6 and N6-lubricant.

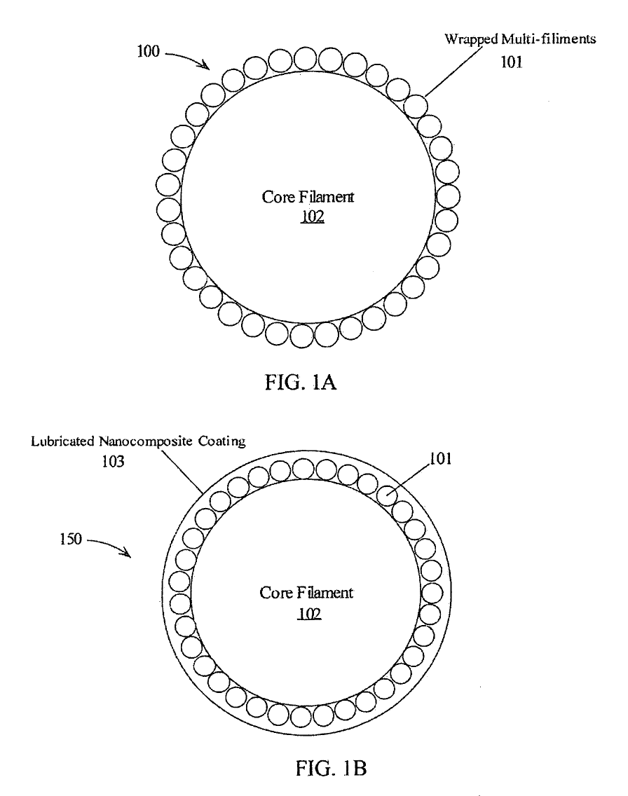

FIG. 1A is a cross-section of a string 100 with a solid core filament 102 and one or more outer wrapped multi-filaments 101. FIG. 1B is a cross-section of one embodiment of a string 150 with a solid core filament 102 and one or more outer wrapped multi-filaments 101 and a coating 103.

The string, subject to coating, has one solid core filament with one or more outer wrapped multi-filaments. The lubricated nanocomposite coating is produced by extrusion process at temperature ranging from 240° C. to 280° C. In one embodiment, the thickness of the wear-resistant composite coating may be between 50 and 100 micrometers. The strings coated with composite #1 listed in FIG. 3 may be used to make a net of a racquet, e.g., the net of a tennis racquet. The coated strings were strung in racquets and tested for their abrasion resistance by hitting balls. A comparison test was made using racquets strung with a commercial neat N6. The durability and thus lifetime of strings coated with lubricated nanocomposite #1 was shown to be over 12% better than strings coated with neat N6.

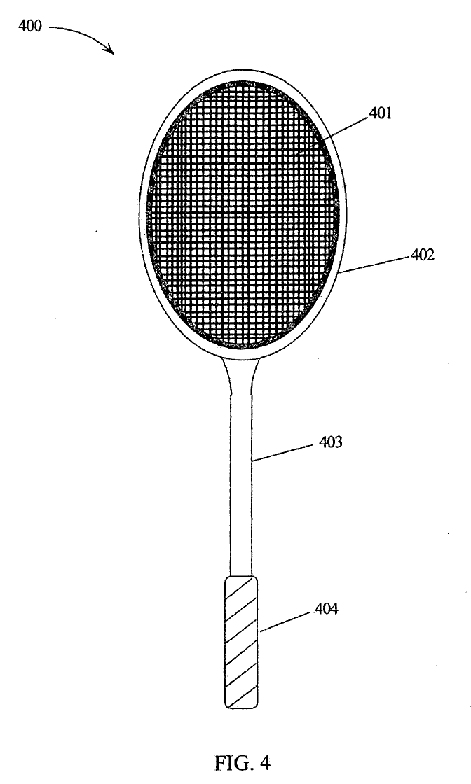

FIG. 4 illustrates an exemplary sports racquet 400 suitable for utilizing strings made according to embodiments herein. The racquet head 402 is strung with strings in an overlapping pattern forming the net of the racquet. The racquet handle 403 connects the racquet head 402 with the racquet grip 404.

A number of embodiments of the invention have been described. Nevertheless, it will be understood that various modifications may be made without departing from the spirit and scope of the invention. For example, a buffer layer may also be used before a lubricated layer is coated. The buffer layer may be used to promote the adhesion of lubricated nanocomposite coatings on strings. The materials used for the buffer layer may comprise other types of N6 or one of the lubricated nanocomposites listed in FIG. 3 that are compatible with both lubricated nanocomposites and string materials.

What is claimed is:

1. A material composite comprising rigid nanoparticles, and lubricated nylon.

2. The composite of claim 1, wherein the rigid nanoparticles comprise carbon nanotubes or clay particles.

3. The composite of claim 1, wherein the lubricated nylon may comprise graphite, molybdenum disulfide, Silicone, Teflon®, and titanium dioxide.

4. The composite of claim 1, further comprising impact modifiers selected from a set of impact modifiers including styrene-ethylene/butylene-styrene (SEBS), maleic anhydride grafted ethylene and propylene copolymer, a plasticizer, a compatiblizer, and combinations therein.

5. The composite of claim 1, wherein processes of formation include extrusion, melt compounding, and in-situ polymerization.

6. The composite of claim 1, wherein a content of the rigid nanoparticles ranges between 0.1-30% by weight, a content of the lubricant ranges between 0.01-20% by weight, and a content of the nylon ranges between 70-99.9% by weight.

7. The composite of claim 2, wherein the carbon nanotubes include single-wall carbon nanotubes, double wall carbon nanotubes, multi-wall carbon nanotubes, purified or non-purified carbon nanotubes, metallic or semiconducting carbon nanotubes, or combinations thereof.

8. The composite of claim 1, wherein the nylon may be nylon 6, nylon 11, nylon 12, nylon 6/6, or combinations thereof.

9. A string configured for use in sporting goods or musical instruments comprising:
a cylindrical center core of plastic material;
one or more outer filaments of plastic material wrapping the core; and
a material composite coating applied to the string, the material composite including rigid nanoparticles, and lubricated nylon.

10. The string of claim 9, wherein the coating thickness ranges between 0.1-200 μm.

11. The string of claim 9, wherein the string is coated with the material composite using a melt-compounding (extrusion) process or a solution coating process.

12. The string of claim 9, wherein the rigid nanoparticles comprise carbon nanotubes or clay particles.

13. The string of claim 9, wherein the lubricated nylon may comprise graphite, molybdenum disulfide, Silicone, Teflon®, and titanium dioxide.

14. The string of claim 9, wherein the material composite further comprises impact modifiers selected from a set of impact modifiers including styrene-ethylene/butylene-styrene (SEBS), maleic anhydride grafted ethylene and propylene copolymer, a plasticizer, a compatiblizer, and combinations therein.

15. The string of claim 9, wherein a content of the rigid nanoparticles ranges between 0.1-30% by weight, a content of the lubricant ranges between 0.01-20% by weight and a content of the nylon ranges between 70-99.9% by weight.

16. The string of claim 12, wherein the carbon nanotubes include single-wall carbon nanotubes, double wall carbon nanotubes, multi-wall carbon nanotubes, purified or non-purified carbon nanotubes, metallic or semiconducting carbon nanotubes, or combinations thereof.

17. A racquet having a net of strings each having a cylindrical center core of plastic material, one or more outer filaments of plastic material wrapping the core, and a material composite coating applied to the string, the material composite including rigid nanoparticles, and lubricated nylon.

18. The racquet of claim 17, wherein a thickness of the coating ranges between 0.1-200 μm.

19. The racquet of claim 17, wherein the rigid nanoparticles comprise carbon nanotubes or clay particles.

20. The racquet of claim 17, wherein the-lubricated nylon may comprise graphite, molybdenum disulfide, Silicone, Teflon®, and titanium dioxide.

21. The racquet of claim 17, wherein the material composite further comprises impact modifiers selected from a set of impact modifiers including styrene-ethylene/butylene-styrene (SEBS), maleic anhydride grafted ethylene and propylene copolymer, a plasticizer, a compatiblizer, and combinations therein.

22. The racquet of claim 17, wherein processes forming the material composite include extrusion, melt compounding, and in-situ polymerization.

23. The racquet of claim 17, wherein a content of the rigid nanoparticles ranges between 0.1-30% by weight, a content of the lubricant ranges between 0.01-20% by weight and a content of the nylon ranges between 70-99.9% by weight.

24. The racquet of claim 20, wherein the carbon nanotubes include single-wall carbon nanotubes, double wall carbon nanotubes, multi-wall carbon nanotubes, purified or non-purified carbon nanotubes, metallic or semiconducting carbon nanotubes, or combinations thereof.
